(19) United States
(12) Patent Application Publication
(10) Pub. No.: US 2009/0121042 A1
(43) Pub. Date: May 14, 2009

(54) Hand held sanitary washer

(76) Inventor: Ragai Mitry, Mattoon, IL (US)

Correspondence Address: MICHAEL L. ANTOLINE P.C., ONE EAST MAIN STREET, SUITE 212, CHAMPAIGN, IL, 61820, US

(21) Appl. No.: 12/220,731

(22) Filed: Jul. 28, 2008

Related U.S. Application Data
(60) Provisional application No. 60/962,385, filed on Jul. 27, 2007.

(51) Int. Cl. B05B 7/00

(52) U.S. Cl. 239/61

(57) ABSTRACT

The Hand Held Sanitary Washer provides a mechanism to deliver soap, water or a soap and water mixture. Soap delivery is accomplished through a venture mechanism or through compressive means. A soap reservoir may be detachable or included within the sanitary washer handle. Water aeration diminishes splashing as well as aiding in the mixture of soap and water. The addition of temperature controlled water is provided for and various attachment means to existing plumbing facilities are provided.

### CROSS REFERENCE TO RELATED APPLICATIONS

This application claims the benefit of Provisional Patent Application 60/962,385 filed Jul. 27, 2007.

### FEDERALLY SPONSORED RESEARCH

Not applicable.

### SEQUENCE LISTING OR PROGRAM

Not applicable.

### BACKGROUND OF THE INVENTION

1. Field of Art

The invention relates to a hand held sanitary washer or hand-held bidet.

2. Prior Art

The advantages of using running water for personal hygiene are well known, and the practice, more widespread in some parts of the world, is becoming more prevalent in the United States. This invention incorporates the addition of liquid soap and other modifications to facilitate e its use. The term “soap” appearing anywhere in this application refers to any substance that can be dispensed, including disinfectants, medications, lotions, etc.

The advantages of washing with soap, compared to washing with water only, are self-evident. The presence of soap dramatically increases the cleansing action of water by creating a film which bonds to the undesired organic matter, said film being easily rinsed afterwards. This results in a much more complete cleaning action, as well as leaving the user feeling fresh and pleasant smelling.

While the principle of a cleaner perineum should appeal to everybody, there are some conditions that make this device almost essential. Those suffering from hemorrhoids experience significant pain and bleeding from wiping with paper towels. Any person afflicted with perineal conditions such as an abscess, fistula, trauma, would similarly benefit from the use of this device. The device is also suitable for improving female genital hygiene.

Inventors have created several types of bidet-type washers. U.S. Pat. No. 4,890,340 to Lovitt describes one such device. In the is apparatus, the amount of water is limited to what can be filled inside the device since there is no source of constantly running pressurized water. The device also has no provision for supplying warm water. It has no way to deliver soapy water and no anti-splashing features. The same limitations also apply to another portable perineum cleaning device described by U.S. Pat. No. 6,955,662 B2 to Moser et al.

U.S. Pat. No. 4,195,369 to Lesick, describes a portable bidet attachment. It involves supplying water from a sink faucet to an apparatus that clamps on the back of the toilet rim. It is a bulky device that requires prior installation on the toilet rim with clamps. After installation, the ability to finely control the aim of the water during use is not possible. To change from cleaning the anal area to cleaning the female genitalia, the user would have to unclamp the whole apparatus from the posterior rim of the toilet bowl and reattach it to the front rim of the toilet bowl. The water tube that connects from a sink faucet would be a nuisance if left permanently in place, and therefore the design is not good for long-term use. The clamps described are bulky and would abut against the user's buttocks while sitting down. In addition, to clean around and underneath the clamps, the user would have to remove those clamps. The device has no aerator to reduce splashing, no removable head, and no filtration ability. A major drawback is the lack of ability to deliver soapy water.

U.S. Pat. No. 7,127,750 to Lim, also describes a hand-held bidet apparatus. Lim's apparatus is not portable and the sprayer head also does not have an aerator. Lim does not describe any means of making the device adapted to portable or outdoor use. A major drawback to Lim's invention is the lack of any soap delivery provision.

U.S. Pat. No. 6,973,679 to Schad describes a personal cleansing spray device with an integrated trigger mechanism. The design uses a gun-shaped sprayer and a squeezable trigger. It has an external soap reservoir, which is connected to the handle via an external soap supply tube. It can readily be seen that its gun-shaped spray handle will be very difficult to aim upwards, and simply cannot allow the fine movements necessary for a device of this nature to be effective. This difficulty in aiming the water spray can result in the unintentional splashing of the back of the toilet seat, the users back, and into the toilet bowl itself. This is clearly undesirable, as it poses the risk of splashing dirty toilet water back onto the user. This is completely avoided with the current design, since the water jet is naturally directed upwards, and the water falls passively in the toilet bowl. Schad's external soap supply tube also adds bulk to the connection from water source to handle, and this extra-bulk will make it unwieldy to maneuver the hose. Furthermore, Schad indicates the use of a soap release button on the side of the handle, without showing internally how it could work. There is no description of a clear embodiment with a plausible soap pumping mechanism. In addition, even if the soap supply button can work somehow, the user has to pump soap the whole length of the external soap supply tube before any soap gets out. There are also no design features for mixing soap with water, such as a mixing chamber. In addition, Schad does not describe any means of portability for outdoor use or use away from home, a removable head, or antisplashing mechanism such as an aerator. All these deficiencies are solved in the current design.

U.S. Pat. No. 5,991,937 to Safara describes a hand held bidet with soap. However, soap comes out without mixing with water. Therefore, the undiluted soap will reach certain spots and miss others, and unless the user pumps soap repetitively, may miss the most soiled spots altogether. Also, some undiluted soap can drip back in the toilet bowl and be wasted. Safara's design has no provision for refilling the soap bladder. It is also apparent that water could reflux into the soap bladder, thus causing progressive dilution of the soap over time and thus reducing its cleaning effect. The water and soap delivery systems and controls are problematic. Safara describes a three-position slide switch (off position, water only position, wash-soap position). This switch operates a spring-biased roller to squeeze a soap bladder. The switch can possibly deliver one dose of soap as it is pushed forward into the wash soap position, but is not able to deliver additional doses from that position, unless the roller is repeatedly moved forward and backwards. This single slide switch apparently does not control both water flow and soap delivery.

Safara also does not describe a detachable head, and therefore his device would be only a single user device. Any potential for commercial multi-user use such as in a hospital setting, would not be possible

U.S. Pat. No. 4,903,347 to Garcia et. al. describes a cleansing that is not a hand-held. It is a large, bulky, commode-like design, utilizing electrical pumps and has provisions for automatic toilet flushing. It is aimed essentially at the physically handicapped population and their caregivers. With its bulk and cost involved, it offers no benefit to the average consumer. Multi-individual use is also excluded. There are no provisions for eliminating splashing.

### OBJECTS AND ADVANTAGES

Several objects and advantages of the present invention are:

(a) to provide a cleansing apparatus with a constant, virtually unlimited source of pressurized, temperature controlled water.
(b) to provide cleansing apparatus that is capable of introducing soap and producing a soap and water mixture.
(c) to provide a cleansing apparatus that reduces unhygienic splashing of the water stream.
(d) to provide a cleansing apparatus with an efficient profile that allows unobstructed cleaning of the surrounding toilet facility or basin.
(e) to provide a cleansing apparatus that reduces the possibility of cross contamination allowing use by more than one person thereby increasing the value of the device in an institutional setting.
(f) to provide a cleansing apparatus with filtration capabilities.
(g) to provide a cleansing apparatus that allows the user to easily direct the water jet to the desired area of the perineum or other target, and doing so while holding the handle in a relaxed manner, and without applying any undue strain on the wrist, the user's hand is kept well away from the buttocks further enhancing infection control and cross contamination.
(h) to provide a cleansing apparatus with an internal soap reservoir that avoid the aspiration of water into the compartment thereby avoiding the dilution and loss of effectiveness of soap or disinfectant.

Although the design was inspired by a need to improve personal hygiene of the perineum and other body areas, and to extend this enhanced hygiene to a large number of people at a reasonable cost, the device lends itself to other intuitive uses. In the first aid setting, this device can be used to perform an initial cleansing of grossly contaminated wounds. Pet owners can use it to help in washing their pets with more ease, without having to stop to open a pet shampoo container, pour the shampoo onto a hand, and lather it into the animal's fur. With the animal being held with the non-dominant hand, the user can use the dominant hand to spray shampoo, then water, then more shampoo, without letting go of the animal. The device can be extended to use in the bathtub or shower, either for body washing or for cleaning the shower or tub walls. The device can also be used in kitchen sinks, produce departments or any other location where cleaning is done.

### BRIEF DESCRIPTION OF THE DRAWINGS

FIG. 1 is a plan view of the washer.

FIG. 2 is a cross-sectional view along line 1-1 from FIG. 1.

FIG. 3 is a cross-sectional view of the handle at the level of the line 2-2 from FIG. 2.

FIG. 4 is a cross-sectional view of the handle at the level of the line 3-3 from FIG. 2.

FIG. 5 is a longitudinal section view of an embodiment using a collapsible soap reservoir, plunger-in-a-barrel type.

FIG. 6 is a cross-sectional view along the line 4-4 from FIG. 5.

FIG. 7 is a cross-sectional view of an embodiment using a collapsible soap reservoir, collapsible side wall type.

FIG. 8 is a plan view of an embodiment featuring positive pressure creation inside the soap compartment, using a spring backed piston mechanism.

FIG. 9 is a cross-sectional view of the embodiment in 8 along the line 5-5.

FIG. 10 is a top view of an embodiment featuring positive pressure creation inside the soap compartment, using a compressed air/gas mechanism.

FIG. 11 is a cross-sectional view of the embodiment in 10 along the line 6-6.

FIG. 12 is a plan view of the device of an alternative embodiment.

FIG. 13 is a cross-sectional view along the line 7-7 from FIG. 12.

FIG. 14 cross-sectional view of an alternate head design with a mixing chamber and aerator.

FIG. 15 is a cross-sectional view of an alternate embodiment with the soap compartment in the upper portion of the handle.

FIG. 16 is perspective view of a removable head with a built-in mixing chamber and aerator.

FIG. 17 is a perspective view of an arrangement to connect a hot water line to the device.

FIG. 18 a perspective view of an electric water heater connected to the device.

FIG. 19 a perspective view of how the device can be connected to hoses of a variety of diameters using a new garden hose adapter.

FIG. 20 a perspective view of a global view of the device connected to a faucet using a universal faucet adapter.

FIG. 21 is a partial cross-sectional view of a new universal faucet adapter.

FIG. 22 is an expanded perspective view of a new universal faucet adapter, of the double threaded type, connected to a segment of plastic tubing.

FIG. 23 is a partial cross-sectional view of a new universal faucet adapter, of the rubber headed type, connected to a segment of plastic tubing.

FIG. 24 is an expanded perspective view of a new universal faucet adapter, of the rubber headed type, connected to a segment of plastic tubing.

FIG. 25 is partial cross-sectional view of a segment of plastic tubing connected to the bidet using a specialized compression bidet adapter.

FIG. 26 an expanded perspective view of a segment of plastic tubing connected to the bidet using a specialized compression bidet adapter.

FIG. 27 is a cross-sectional view of the detachable soap reservoir detached from the handle.

COMPONENT LIST

| | |
|---|---|
| handle | 1 |
| proximal handle end | 1a |
| distal handle end | 1b |
| sprayer head | 2 |
| cradle | 2a |
| soap reservoir | 3 |
| reduced reservoir | 3a |
| transparent reservoir wall segment | 3b |
| water actuator | 4 |
| soap actuator | 5 |
| soap filler cap | 6 |
| water inlet | 7 |
| water outlets | 8 |
| male threads | 9 |
| one way soap valve | 10 |
| water channel | 11 |
| soap and water channel | 11a |
| water channel | 11b |
| plunger | 12 |
| plunger sliding forward in barrel | 12a |
| first locking hook | 13 |
| second locking hook | 13a |
| third locking hook | 13b |
| first locking latch | 14 |
| first piston | 14a |
| second piston | 14b |
| rubber seal | |
| first spring | 14c |
| second spring | 14d |
| first piston rubber seal | 14e |
| second piston rubber seal | 14f |
| second locking latch | 14g |
| third locking latch | 14h |
| first one way valve | 14i |
| second one way valve | 14j |
| collapsible side walls in full position | 15 |
| collapsible reservoir | 15a |
| collapsible side walls in empty position | 16 |
| skeleton | 17 |
| air vent | 18 |
| small pump | 19 |
| pump cavity | 19a |
| soap uptake tube | 20 |
| soap delivery tube | 22 |
| one-way valve | 23 |
| second one-way check valve | 23a |
| mixing chamber | 24 |
| aerator | 24a |
| replaceable head | 25 |
| aerator slots | 26 |
| aerator meshes | 27 |
| snap-on connector | 28 |
| water tank | 29 |
| cold water valve | 30 |
| first t-connector | 31 |
| second t-connector | 31a |
| cold water valve supplying to t-connector | 31b |
| cold water hose | 32 |
| hot water valve | 33 |
| hot water supply hose | 33a |
| warm water supply tube | 34 |
| water filter | 34a |
| optional water heater, electric | 35 |
| hose | 36 |
| warm water supply hose | 37 |
| power switch | 38 |
| thermostatic controller | 39 |
| power cord | 40 |
| electrical outlet | 41 |
| garden hose | 42 |
| large male threads | 43 |
| hose adapter | 44 |
| female threads | 45 |
| smaller female threads | 46 |
| universal faucet adapter | 47 |
| universal coupler | 47a |
| universal coupler internal threads | 47b |
| universal coupler external threads | 47c |
| coupler male threaded lower stem | 47d |
| coupler collar | 47e |
| compression coupler | 48 |
| rubber seal | 48a |
| brass insert | 49 |
| brass sleeve | 50 |
| brass nut | 51 |
| female threads | 51a |
| plastic tubing | 52 |
| universal faucet adapter | 53 |
| rubber head | 53a |
| rubber neck | 53b |
| rubber stem | 53c |
| internal rubber ridges | 53d |
| intermediate brass coupler | 54 |
| intermediate brass coupler male threads | 54a |
| compression coupler | 55 |
| bidet adapter | 56 |
| external housing of bidet adapter | 57 |
| hose clamp | 58 |
| wing headed screw | 58a |
| water tube release bushing | 59 |
| tube grip lock washer | 60 |
| water tube locking casing | 61 |
| rubber washer | 62 |
| water inlet grommet | 63 |

### DETAILED DESCRIPTION

### Preferred Embodiment

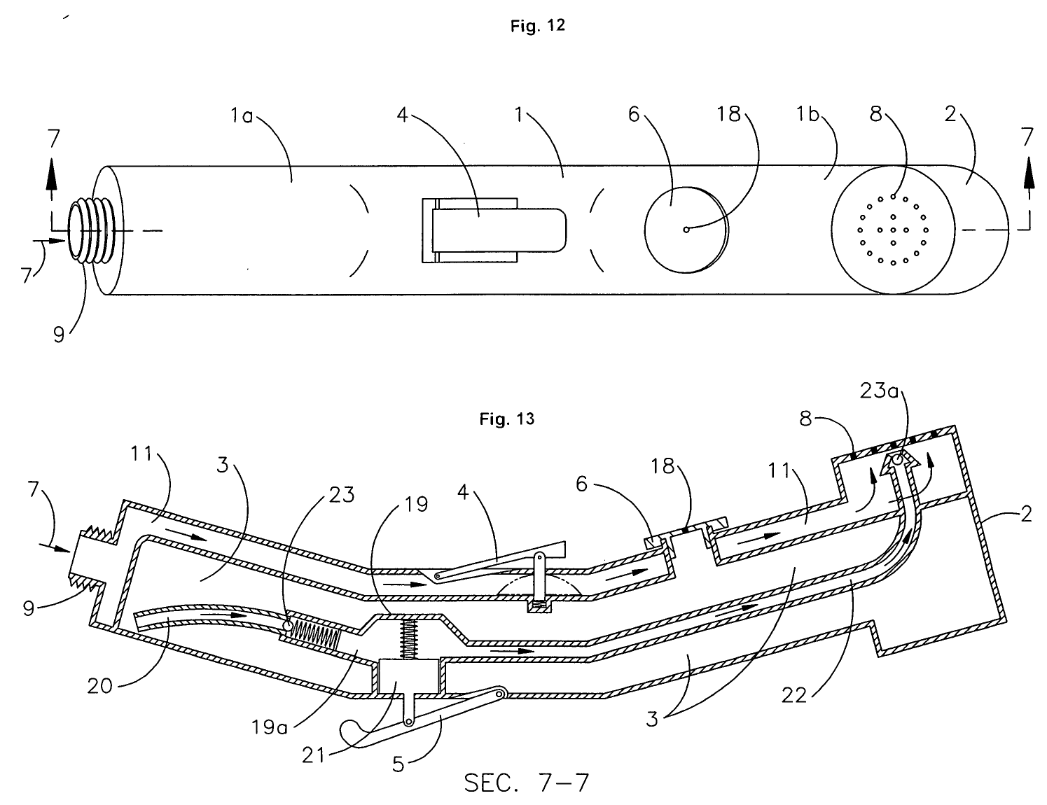

The preferred embodiment is illustrated in FIG. 12 and FIG. 13. This embodiment consists of a handle 1, a sprayer head 2, a built-in soap reservoir 3, a water actuator 4, a soap actuator 5, and a soap filler cap 6. The proximal handle end 1a receives the water inlet 7, and the distal handle end 1b connects to the head 2. The body of the handle is hollow, mostly cylindrical shape, but can be of other shapes. Preferably, it will be made of injection molded plastic, but metal or other suitable materials can be substituted. The top surface of the body of the handle incorporates an actuator 4 to control the flow of water. In the embodiment shown in FIGS. 12 and 13, the actuator 4 would be pressed down with the user's thumb. The top surface features a filler cap 6 to allow the addition of soap to the soap reservoir 3. A feature of the device would incorporate a transparent reservoir wall segment 3b wall as show in FIG. 2 that will allow the user to monitor the level of soap being used and to plan to refill accordingly. 18: one way air vent.

FIG. 13 shows a working view of the device. The arrows represent the direction of fluid flow. The water enters the handle at the water inlet 7 and into the water channel 11. The top surface of the handle incorporates a water flow-controlling actuator 4, in this embodiment a push button with a built spring. The water then flows under pressure into the head 2 and through the water outlets 8. A circular array of the water outlets is shown but can vary.

The bottom surface of the handle shows an actuator 5 to release soap from the soap reservoir 3, which is aspirated by a small pump 19 via a soap uptake tube 20. The soap propelling mechanism is here represented by a 2-stroke, reciprocating piston pump 19, but other mechanisms can be used. The soap then moves across a one-way valve 23 into the pump cavity 19a. This one-way valve 23 prevents the backflow of soap into the soap reservoir 3 when the trigger 5 is activated. The soap is then pumped under pressure into a soap delivery tube 22 that reaches the head 2. However, the soap delivery tube 22 can be embodied to join the water channel more proximally. The soap then exits the head 2 under pressure, to be sprayed onto the perineum. A second one-way check valve 23a at the soap outlet prevents back flow of air or water into the soap delivery tube.

Two major embodiment classes were described above, but different variations can be envisioned. The main concepts of the design can be adapted in different ways, to accommodate different user preferences or manufacturing efficiency, without deviating from the substance of the design. These different embodiments are listed as a matter of illustration and are not meant to be limiting the applicability of this versatile design.

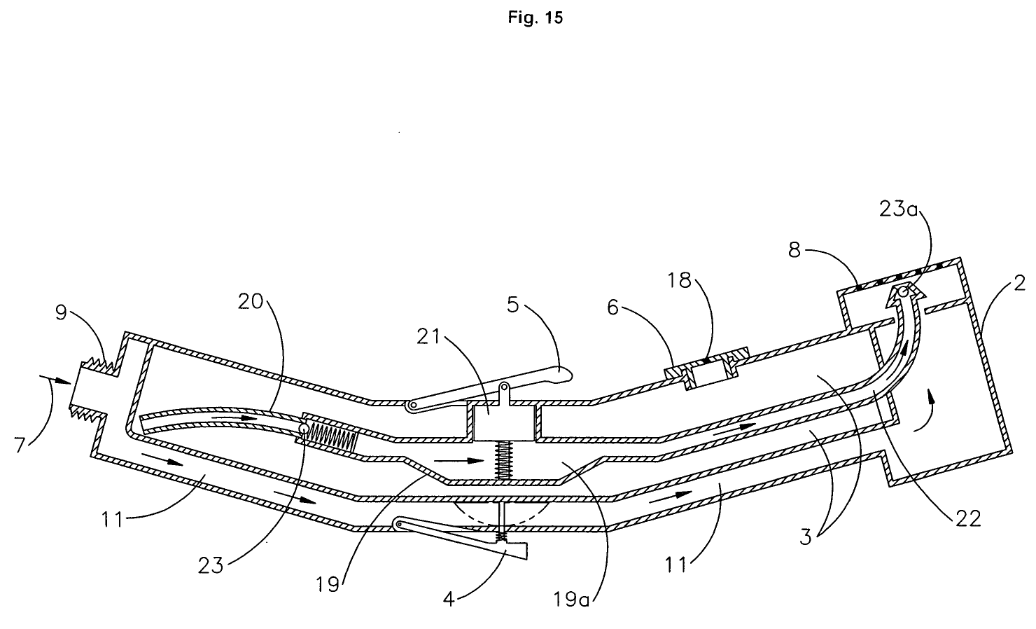

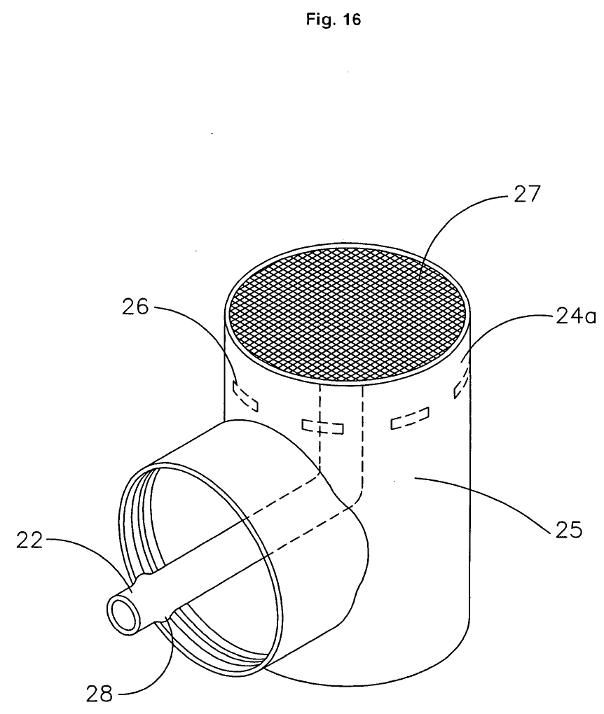

Any permutation of the position of the actuators relative to each other and relative to the body of the device may be offered. For example, the position of the two actuators can be reversed, with the soap actuator 5 on the top of the handle and the water actuator 4 on the bottom (FIG. 15). Some users may prefer the repetitive pumping action of the soap actuator to be done with the thumb rather than with the second and third fingers. The actuators can also be placed side by side, either at the top or the bottom of the handle. Placements on the sides of the device can also be done.

The cylindrical handle can be replaced with any other suitable design of a different dimension, i.e., different length, width, volume or cross-sectional shape (square, rectangle, hexagonal, octagonal, etc).

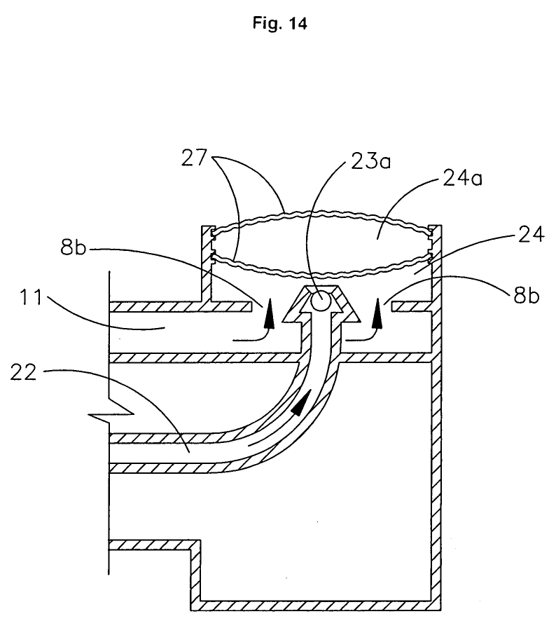

FIG. 14 shows a variation of the head of the device. The soap exits the one-way valve 23a and joins the water outlets 8b, which open into a common mixing chamber 24 and the aerator 24a just prior to exiting aerator meshes: 27. The cleansing action of the soapy water would be more effective than simply spraying the soap directly on the perineum. Direct soap application may miss soiled areas, since the user cannot see his/her target, and that wastes soap.

The aerator also prevents splashing of liquid from the perineum. Eliminating splashing is an improvement over the prior artMixing of the soap with water and the addition of an aerator which improves the mixing of the soap and water are also improvements over the prior art. The mixing chamber and/or aerator can also be made as a replaceable head 25 as shown in FIG. 16. A variation of the soap supply tube 22 can have a snap-on connector 28 that would attach to a corresponding concavity in the segment of the soap supply tube on the distal end of the handle. Aerator air slots 26 can also improve the effectiveness of the aerator, thus further reducing splashing and the mixing of air and water.

This replaceable head 25 allows for easy cleaning of the device, such as soaking it in disinfectant. Head 25 can also be marked on the outside with identifying numbers or letters, thus allowing each family member or user to have his/her own individually marked head. This seen in the prior art. The replaceable aerator/mixing chamber can also be disposable, thus allowing for more hygienic use in guest bathrooms, vacation homes, or other locations involving multiple users. Such sanitized, disposable attachments can be provided in individually sealed packages in commercial establishments such as restaurants, hotels, office buildings, etc. The prior art does not provide for hygienic, multi-user adaptation.

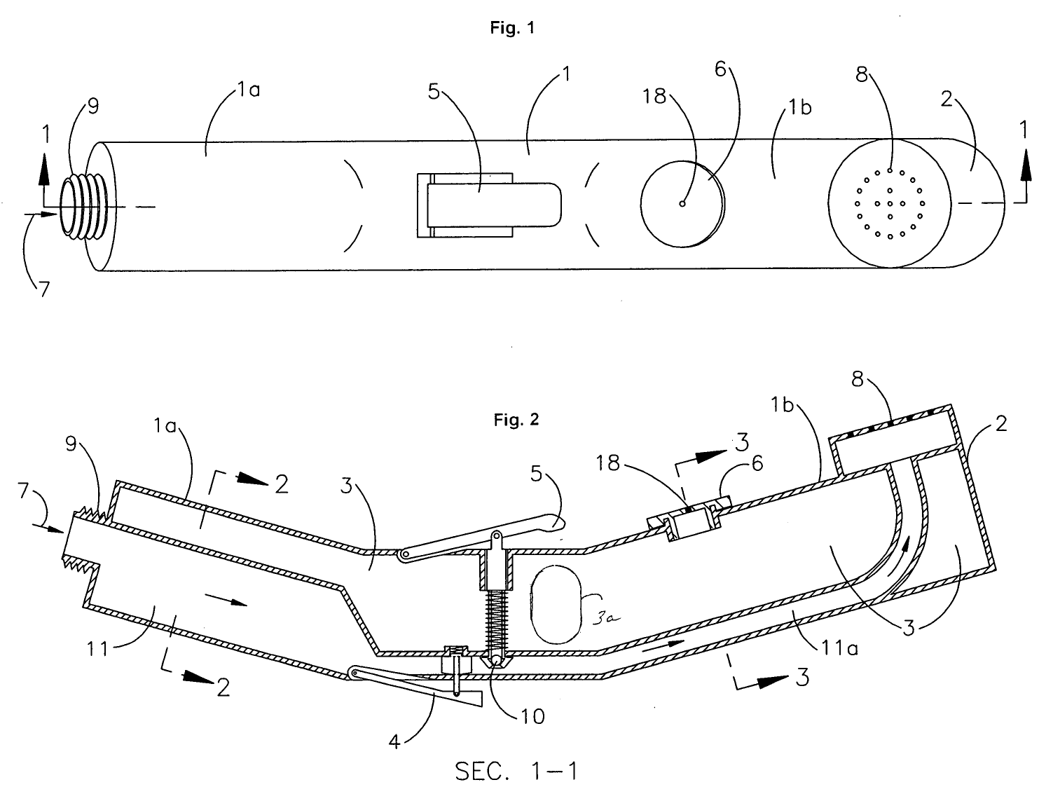

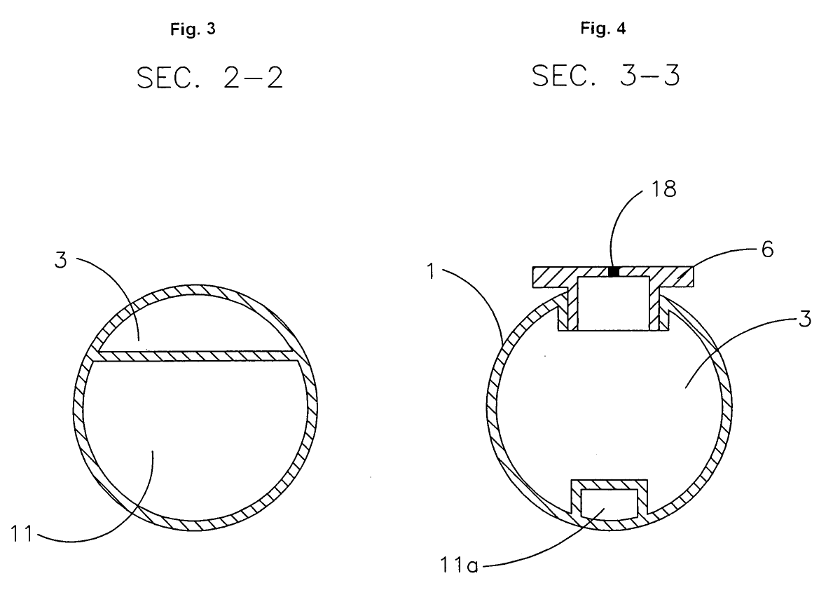

Additional embodiments are shown in FIGS. 1 thru 4. Turning first to FIG. 2, this embodiment consists of a handle 1, a sprayer head 2, a built in soap reservoir 3, a water actuator 4, a soap actuator 5, and a soap filler cap 6. The filler cap 6 can be placed at any location on the soap reservoir. The proximal handle end 1a of handle 1 fluidly communicates with water inlet 7, and the distal handle end 1b connects to the sprayer head 2. For the purpose of this description, “proximal” refers to the upstream portion of the device, or towards the water source. “Distal” refers to the downstream portion of the device, or towards the water outlets 8. The body of the handle is hollow, mostly cylindrical shape, but can be of other shapes. Preferably, it will be made of injection molded plastic, but metal or other suitable materials can be substituted.

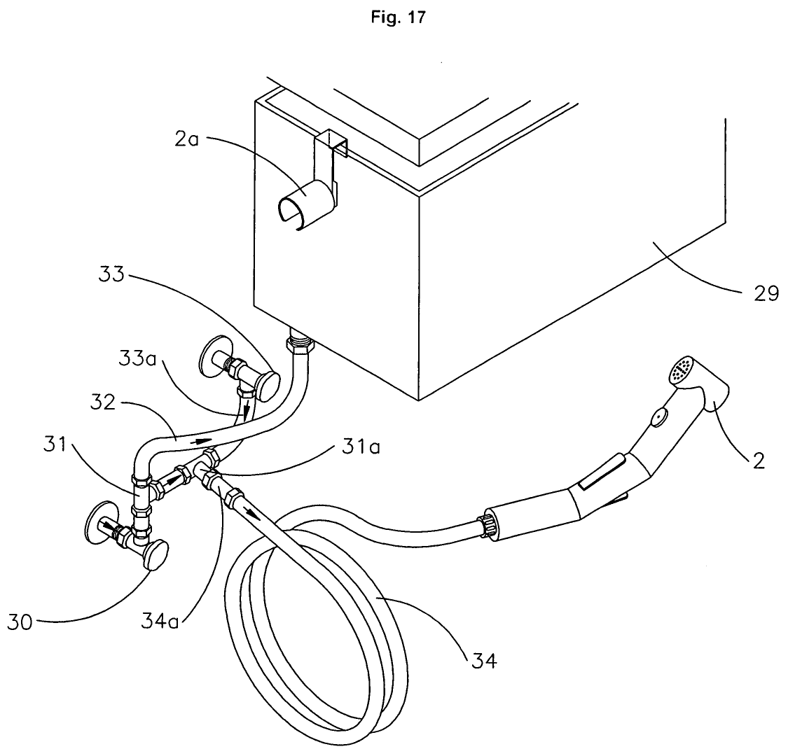

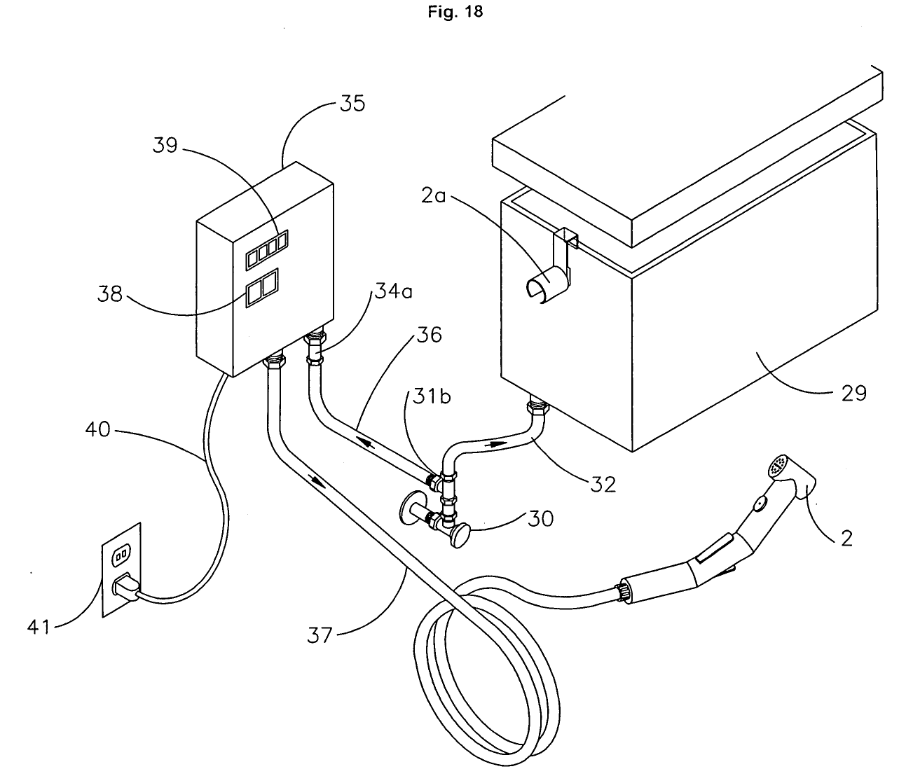

The water pathway is also illustrated in FIG. 2. Water enters under pressure into the proximal end 1a (FIGS. 1 and 2). The arrows indicate the direction of water flow. This embodiment shows the device to connect to a water supply hose 34 as is seen in FIG. 17, via male threads 9 that screw into corresponding female threads on the hose end, but other connection methods are well known in the art. Note that the initial dimension of the water channel 11 is fairly large, but then tapers down to a much smaller diameter prior to the point of attachment of the water actuator 4. However, various embodiments may employ a variety of water channel diameters. The water actuator 4 is represented on the bottom of the handle in this embodiment.

The soap pathway is also illustrated. The bulk of the volume of the handle is occupied by the soap reservoir 3. However, soap reservoirs of various volumes may be employed. Alternatively, as seen in FIG. 27, a separate able soap reservoir can also be made. Soap is poured into the soap reservoir 3 of handle 1 through filler cap 6 on the top surface of the handle, but could be filled by any number of mechanisms such as a one-way valve through which soap may be injected by an injector mechanism. In this embodiment the soap reservoir is designed to extend into a substantial part of the head 2 of the device. The user's thumb depresses the soap actuator 5, depicted on the top surface of the handle 1 in this embodiment. Soap then flows out of the reservoir 3 through a one-way soap valve 10 and into the water channel 11. A feature of the device would incorporate a transparent soap reservoir wall segment 3a that will allow the user to monitor the level of soap being used and to plan to refill accordingly.

Note the significant reduction in the dimensions of the water channel 11. This is designed to accelerate the speed of water, thus lowering its pressure inside the water channel. This in turn creates a pulling force, drawing the soap into the flowing water stream. The Venturi effect, combined with the one-way soap valve 10, prevents the reflux of water in the soap reservoir 3.

The soap and water are mixed together distal to the one-way soap valve 10 in the soap and water channel 11a, created a mixed soap and water pathway. The mixture then flows to the distal handle end 1b, into head 2 of the device and through the water outlets 8. To obtain soapy water, the user pushes both actuators simultaneously, the soap actuator 5 with the thumb and the water actuator 4 with the second and third fingers. To obtain water only, the user pushes only the water actuator 4.

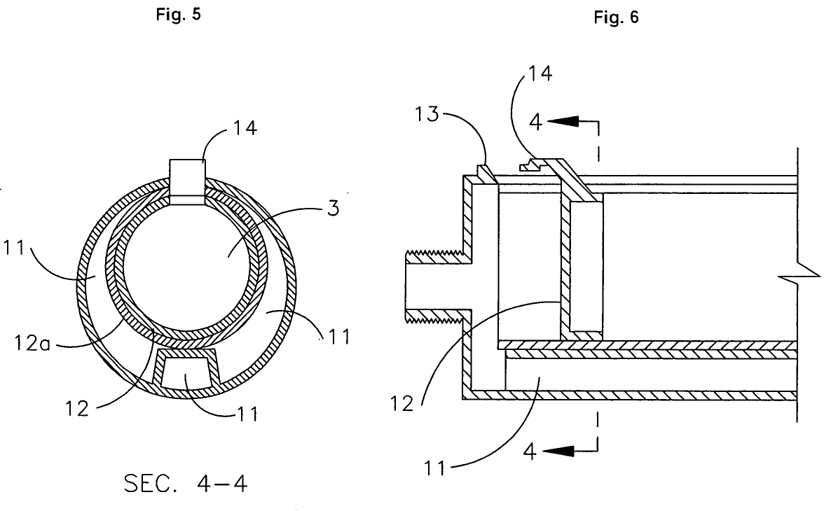

A key feature of the device is to allow the liquid soap to enter the water stream, without the water refluxing into the soap reservoir 3. Such water backflow would progressively dilute the soap in the soap reservoir, and the reservoir will not empty, since water would gradually replace the soap. Preventing water backflow can be accomplished with different design features, which can be used singly or in combination: As is seen in FIG. 2, the soap reservoir opens into the water channel with a one-way soap valve 10. The soap reservoir itself is designed with collapsible, or partially collapsible, surface walls. The force of the water stream will gradually compress one or more sides of the soap reservoir walls. A collapsible reservoir can be made in more than one fashion. FIGS. 5 and 6 illustrate a collapsible plunger-in-a-barrel design, with the plunger 12 moving forward by the water pressure. Said plunger 12 can be manually retracted and held in place during soap refilling with the help of a first locking latch 14, to be attached to first locking hook 13. As the plunger 12 slides forward inside the barrel 12a, the internal dimensions of the soap reservoir diminish, avoiding the creation of negative pressure inside it.

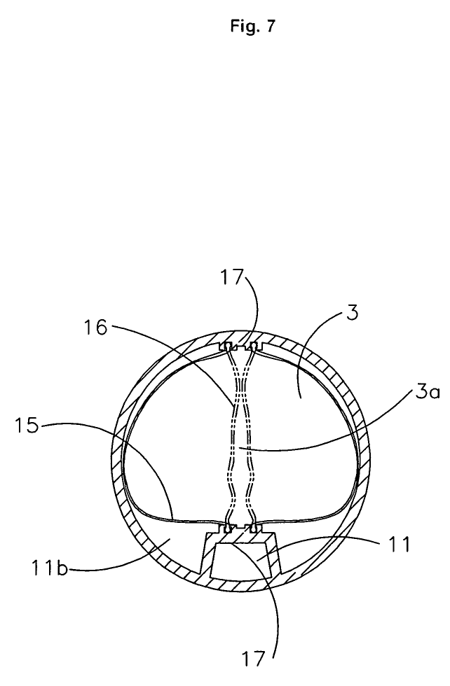

FIG. 7 illustrates collapsible side walls in full position 16, made of a synthetic or other water proof material, alone or attached to a central skeleton 17. Skeleton 17 will have an opening for refilling the soap on one side, preferably on the top of the handle, and an opening into the water channel on another side, preferably towards the bottom of the reservoir. This opening will use a one-way valve. FIG. 7 shows the water channel 11b running outside the skeleton 17, and a water channel 11 running inside skeleton 17 as well. The collapsible side walls in the full position 15 substantially conform to skeleton 17, and collapsible side walls in the near empty position 16 is achieved as the progressive reduction inside the soap reservoir 3 occurs. This avoids the development of negative pressure. Thus the reduced reservoir 3a develops when the size of soap reservoir is reduced in the near empty position.

Coincident use of the plunger and collapsible reservoir is another embodiment. The plunger 12 may be positioned in the back of the handle, and collapsible reservoir 15a in the front of the handle. The opening from the collapsible reservoir 15a into the water channel 11 will be placed in a deliberately designed narrowing of the water channel, taking advantage of the Venturi principle.

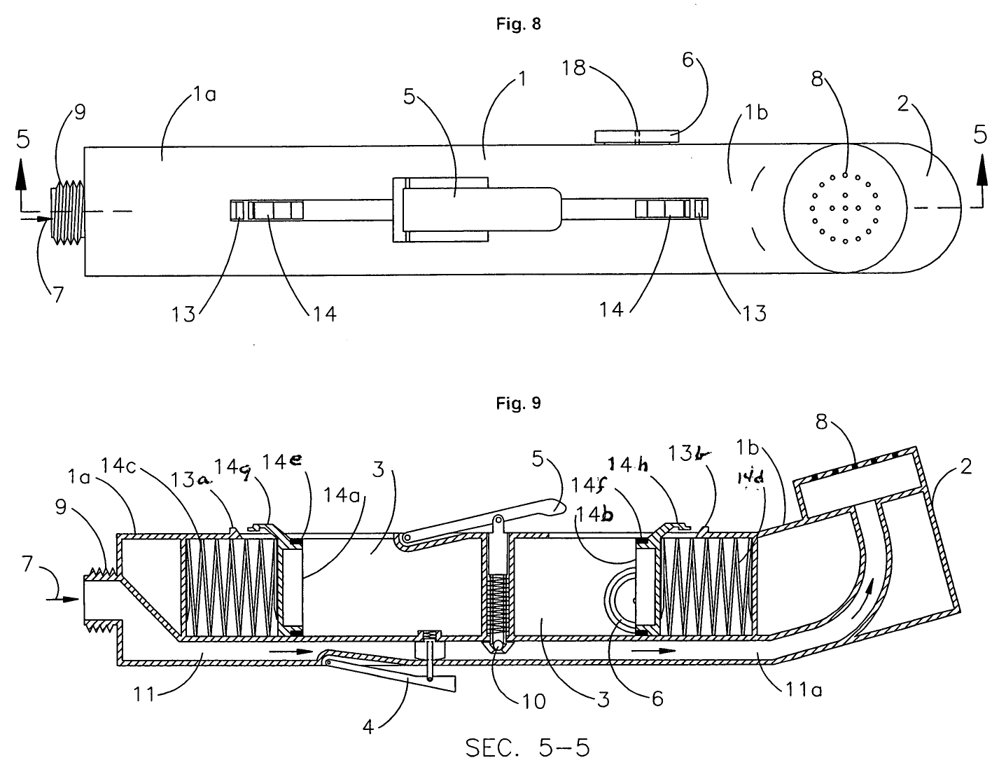

The introduction of liquid soap into the water stream can also occur by creating positive pressure inside the soap compartment, by a spring backed piston mechanism. FIGS. 8 and 9 show an embodiment with two such pistons first piston 14a, and second piston 14b one on each side of the handle, being pushed towards each other by two springs first spring 14c and second spring 14d, thus progressively compressing the soap towards the center of the soap reservoir 3. First piston 14a and second piston 14b exhibit first piston rubber seal 14e and second piston rubber seal 14f to seal the soap inside the soap reservoir. In this embodiment, the soap filler cap 6 would be placed on a side surface of the handle. A second locking latch 14g engages onto second locking hook 13a to hold first spring 14c in position during refilling. A similar mechanism is seen opposite.

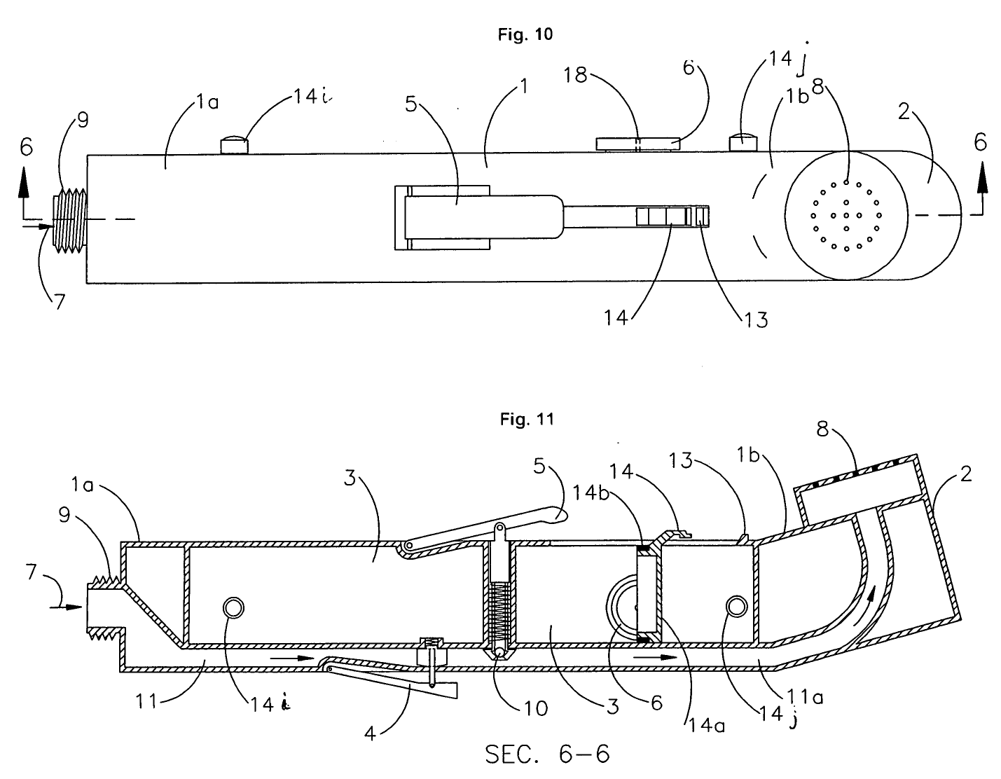

Creating positive pressure inside the soap compartment with an air/gas compression mechanism is seen in FIGS. 10 and 11. Such pressure can be applied though a one way valve 14i from an externally applied air pump, a CO2 cartridge, or a small built in hand pump. Note that the air/gas pressure can be developed directly into the soap compartment itself, as shown when air or gas in injected through first one way valve The air/gas pressure can alternatively be applied through a second one way valve 14j which is behind a sliding piston and rubber seal assembly.

An air vent 18, sown in FIG. 10, or an aperture of a plurality of sizes, built into the soap reservoir, preferably in the soap filler cap 6, will prevent the development of negative pressure inside the soap reservoir as it is being emptied. This may be embodied as a one-way vent, which allows air in but prevents soap from leaking out.

Any of the above embodiments can be provided with warm water capability in two major ways. First, as seen in FIG. 17, by connecting to a hot water supply line. The arrows indicate the direction of water flow An embodiment is shown using a cold water valve 30, which is connected to a first T-connector 31. This first T-connector 31 splits the cold water into two streams. The first stream joins a hose 32, which supplies water to the water tank 29. The second stream goes to a second T-connector 31a.

This second T-connector 31a also receives hot water from a hot water valve 33 via a hot water supply hose 33a. An additional mixing valve can be added at this junction to further fine-tune the ratio of cold to hot water. The warm water then flows from the second T-connector 31a to enter the warm water supply tube 34, which is fluidly connected to the hand-held bidet. An optional water filter 34a is shown in this embodiment. This would be especially useful in areas with elevated water sediments, and will prolong the useful life of the device. The head 2 of the device can be placed in a cradle 2a, which is shown attached to the sidewall of the toilet tank.

FIG. 18 shows the addition of an optional water heater 35, preferably but not necessarily an instant tankless model, readily available in the market. FIG. 18 shows a cold water valve 30 supplying water to a T-connector 31b, which splits the water stream in two. The first stream goes to the water tank 29 via a water hose 32. The second water stream goes to an electric water heater 35 via a hose 36, which becomes the cold intake line of the heater. An optional water filter 34a is shown on the intake line. The heater has a power switch 38 and a thermostatic controller 39 for adjusting the desired temperature. The warm water output of the heater joins the bidet device via a warm water supply hose 37. Also shown are a power cord 40 and an electrical outlet 41.

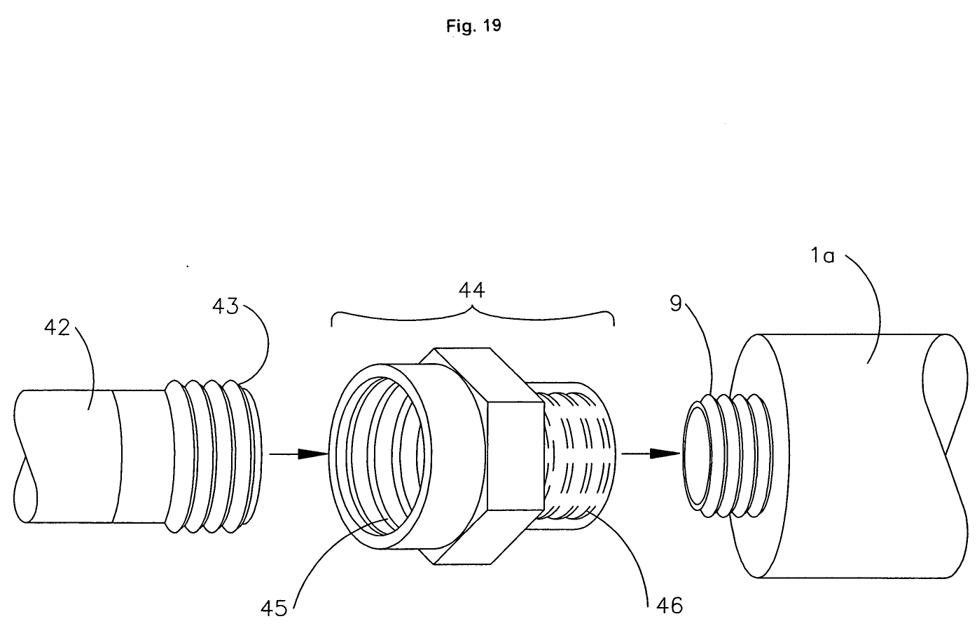

FIG. 19 illustrates a configuration for outdoor use. That Figure shows a new simple garden hose adapter 44 to allow the device to be used outdoors. A garden hose 42 is shown, with large male threads 43 from the end of the hose, which couple with corresponding female threads 45 of an adaptor 44. This adapter 44 has a second set of smaller female threads 46, which in turn couple with the corresponding male threads 9 of the proximal handle end 1a. It is evident that adapters can be made with different combinations of male and/or female threads, in a plurality of sizes, to accommodate a multitude of different hose sizes in different countries.

Outdoor use expands the usage of the device to washing pets, cars or anything else.

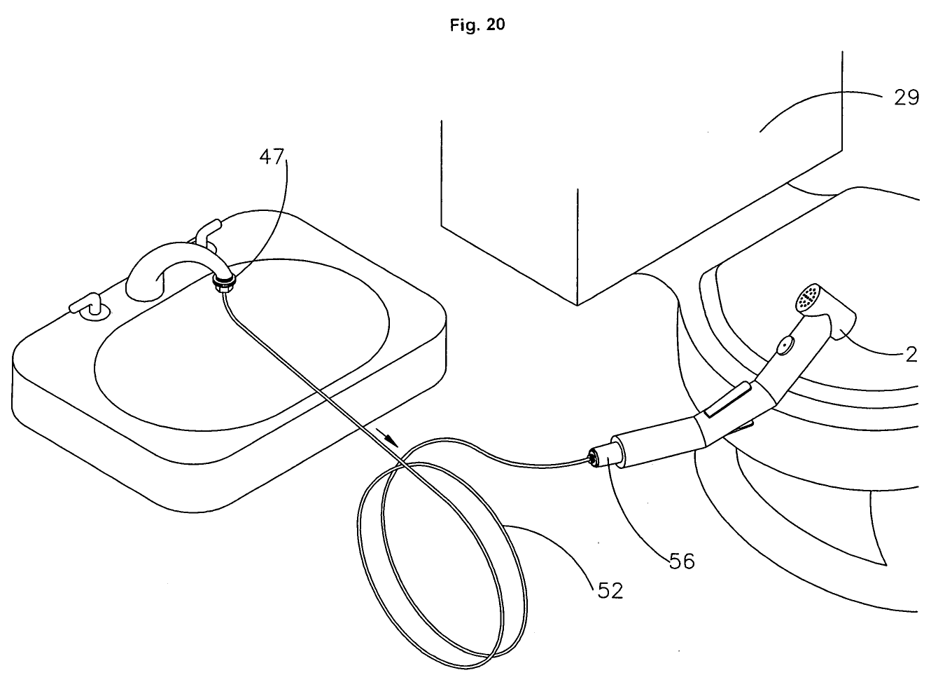

Many individuals would desire to use their bidet device away from home and without having onerous installation steps prior to use. FIG. 20 shows an embodiment in which the bidet device can be connected to a common sink faucet using a new universal faucet adapter 47, a plastic tube 52 and a bidet adapter 56.

Sink faucets come in a multitude of shapes and sizes. There are available in the market universal faucet couplers with dual threading, internal and external, which allow for attaching aerators or other items to almost any faucet design. A common such coupler in the U.S. has 55/64 inch-27 thread and 15/16 inch-27 thread.

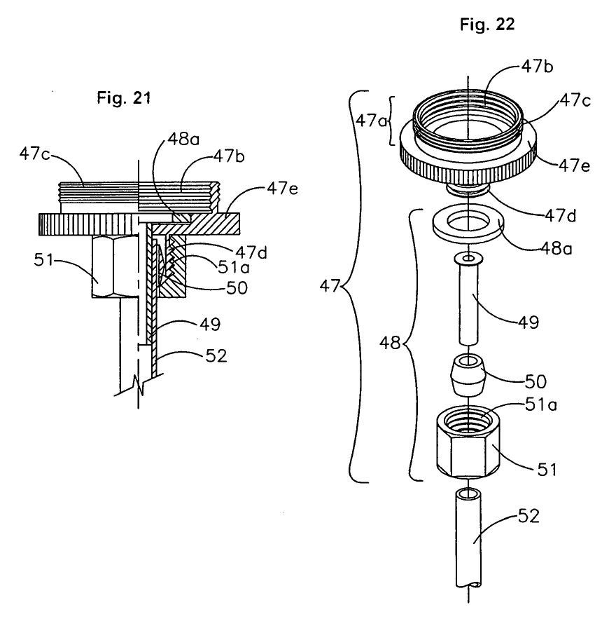

FIGS. 21 and 22, show a new universal, dual threaded, faucet adapter 47. The adapter has a dual threaded universal coupler 47a on the proximal end to attach to most faucets. On the distal end, it has a compression coupler 48 to allow for the attachment of a plastic tube 52 as shown. Common useful external diameters for the plastic tube are ¼ inch and 5/16 inch, but other sizes can also be used. These diameters allow for good water flow, while remaining thin enough for easy coiling for packing/traveling.

Universal coupler 47a exhibits universal coupler internal threads 47b, universal coupler external threads 47c, coupler male threaded lower stem 47d, which will engage into female threads 51a of brass nut 51. Coupler collar 47e, compression coupler 48, rubber seal, 48a and brass insert, 49 will fit snuggly inside plastic tubing 52. Brass sleeve 50, keeps insert 49 from slipping out of tubing 52 and is compressed by brass nut 51a.

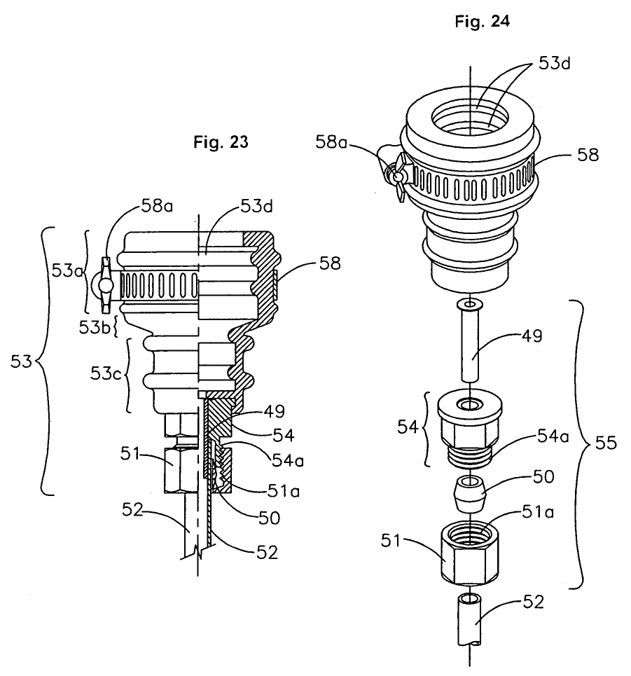

FIGS. 23 and 24, show another new universal faucet adapter 53 with a rubber head 53a on the proximal end to attach compressively to a faucet spout. It has a compression coupler 55 on the distal end to allow for the attachment of a plastic tube 52 as shown. The universal faucet adapter 53 exhibits a cylindrical rubber head 53a connected to a rubber neck 53b further connect to rubber stem 53c. Internal rubber ridges 53d are for grasping onto the faucet spout. Intermediate brass coupler 54, sits in an annular groove inside rubber stem 53c. Intermediate brass coupler male threads 54a: engage female threads 51a of brass nut 51. Brass insert 49 snuggly inside plastic tubing 52. Brass sleeve 50 keeps insert 49 from slipping out of tubing 52. Hose clamp 58 tightens rubber head around a standard faucet spout by wing headed screw 58a. Hose clamps have traditional headed screws, and need a screwdriver to loosen and tighten. This hose clamp with a wing-shaped screw head allows the traveler to use his faucet adapter without carrying a screwdriver.

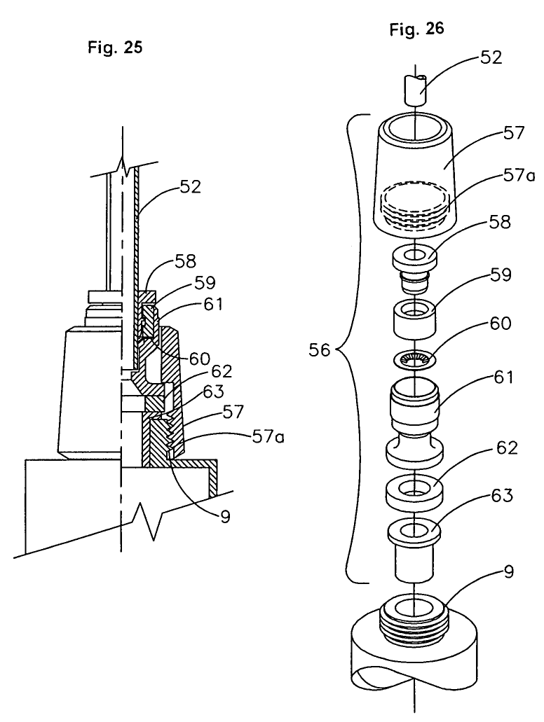

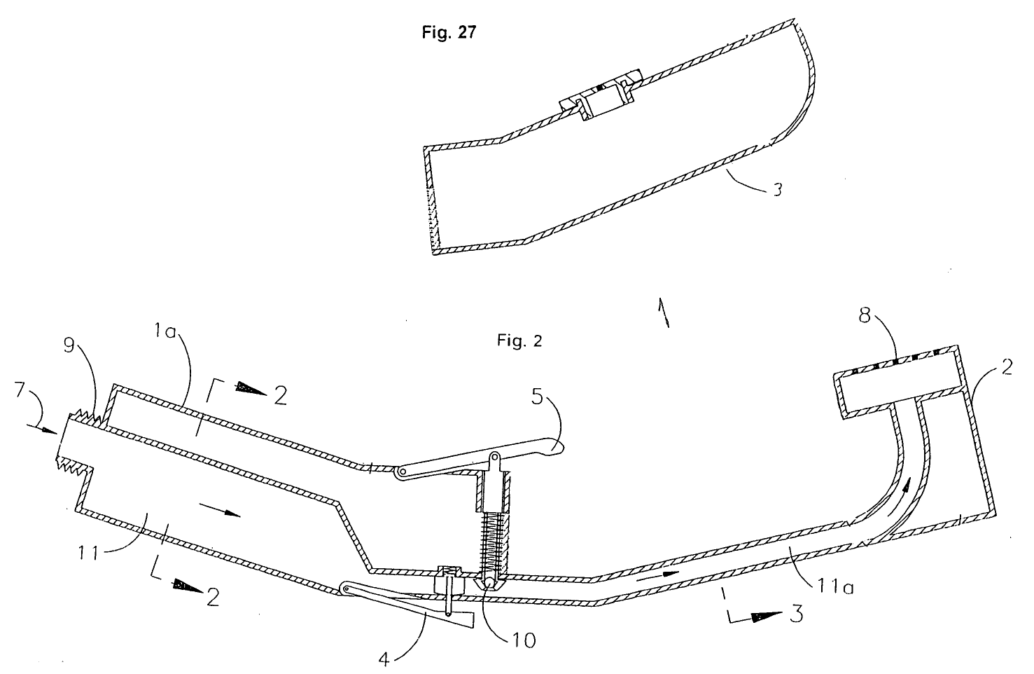

FIG. 20 shows a sink faucet, fluidly connected via a universal faucet adapter 47 to the proximal end of a length of plastic tubing. The distal end of this plastic tubing is connected to the bidet via a bidet adapter 56, as shown in detail in FIGS. 25 and 26.

FIGS. 25 and 26 show external housing of bidet adapter. 57, internal female threads of adapter housing 57a, which will engage onto male threads 9 of bidet device, water tube pressure release 58, water tube release bushing 59, water tube grip lock washer 60, water tube locking casing 61, rubber washer 62 and water inlet grommet 63. Plastic tube 52 threads inside the housing 57, the tube pressure release 58, and tube release bushing 59. The tube can pass through the teeth of the tube grip lock washer 60 only when the tube pressure release 58 is pushed down against the tube release bushing 59. Once the pressure is released, the distally aiming teeth of the grip lock washer 60 grasp the plastic tube 52 tightly and prevent its release. The female threads 57a of the bidet adapter housing 57 engage the male threads 9 of the bidet device. Note that the brass components described above can be made from other metals or from plastic.

The foregoing descriptions of specific embodiments of the present invention have been presented for the purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A hand-held, sanitary washer comprising:
a handle
said handle having a proximal handle end and a distal handle end, said proximal handle end having a water inlet,
a water channel containing water within said handle, fluidly connected to said water inlet,
a soap reservoir within said handle containing soap, said soap reservoir fluidly connected to said water channel, said soap reservoir having walls, said soap reservoir further having a filler cap whereby said soap may be introduced into said soap reservoir,
a sprayer head mounted to said distal handle end and fluidly connected to said water channel, said sprayer head having at least one water outlet fluidly connected to said water channel,
a water actuator connected to said water channel whereby water flow may be controlled,
a soap actuator fluidly connected to said soap reservoir and fluidly connected to said water channel whereby said soap may be introduced into said water channel.

2. The sprayer head of claim 1 further comprising:
an aerator having at least one aerator mesh, said aerator mounted between said water outlet and said water channel whereby water may pass through and be aerated.

3. The sprayer head of claim one whereby said sprayer head may be detached from said distal handle end.

4. The soap reservoir of claim 1 whereby said soap reservoir may be detached from said handle.

5. The reservoir walls of claim 1 wherein said reservoir wall has a transparent segment whereby said soap level may be determined.

6. The filler cap of claim 1 having a one way vent.

7. The handle of claim 1 having at least one angulation.

8. The water channel of claim 1 is narrowed whereby the velocity of the water flow is increased and the pressure is decreased drawing said soap from said soap reservoir.

9. The soap actuator of claim 1 further comprising a one way valve where reflux of water into said soap reservoir is prevented.

10. A hand-held, sanitary washer comprising:
a handle
said handle having a proximal handle end and a distal handle end, said proximal handle end having a water inlet,
a water channel containing water within said handle containing said soap, said soap reservoir fluidly connected to said water inlet,
a soap reservoir within said handle fluidly connected to said water channel, said soap reservoir having walls, said soap reservoir further having a filler cap whereby said soap may be introduced into said soap reservoir, said reservoir having at least one sealably disposed with said reservoir walls whereby said soap may be compressed,
a sprayer head mounted to said distal handle end and fluidly connected to said water channel, said sprayer head having at least one water outlet fluidly connected to said water channel,
a water actuator connected to said water channel whereby water flow may be controlled,
a soap actuator fluidly connected to said soap reservoir and fluidly connected to said water channel whereby said soap may be introduced into said water channel.
a latch whereby said spring driven piston may be secured in a compressed states whereby said soap may be added to said soap reservoir.

12. The piston of claim 11 wherein said piston is spring driven.

13. A hand-held, sanitary washer comprising:
a handle
said handle having a proximal handle end and a distal handle end, said proximal handle end having a water inlet,
a water channel containing water within said handle, fluidly connected to said water inlet,
a soap reservoir within said handle containing soap, said soap reservoir fluidly connected to said water channel, said soap reservoir having walls, said soap reservoir further having a filler cap whereby said soap may be introduced into said soap reservoir, said reservoir having at least one valve whereby air or gas may be introduced compressing said soap.
a sprayer head mounted to said distal handle end and fluidly connected to said water channel, said sprayer head having at least one water outlet fluidly connected to said water channel,
a water actuator connected to said water channel whereby water flow may be controlled,
a soap actuator fluidly connected to said soap reservoir and fluidly connected to said water channel whereby said soap may be introduced into said water channel.

14. The soap reservoir of claim 21, further comprising at least one piston sealably disposed within said reservoir walls, at least one valve whereby air or gas may be introduced whereby pressure may be exerted against said piston whereby said piston compresses said soap.

15. A hand-held, sanitary washer comprising:
a handle said handle having a proximal handle end and a distal handle end, said proximal handle end having a water inlet,
a water channel containing water within said handle, fluidly connected to said water inlet,
a sprayer head mounted to said distal handle end and fluidly connected to said water channel, said sprayer head having at least one water outlet fluidly connected to said water channel, said sprayer head having a mixing chamber wherein said soap and water are mixed.
a soap supply channel said soap supply channel further comprising:
a soap reservoir fluidly connected to a first one way valve whereby said soap may not return to said soap reservoir,
a piston pump fluidly connected to said one way valve whereby soap may be drawn from said soap reservoir,
a second one way valve fluidly connected to said piston pump and disposed within said mixing chamber,
a water actuator connected to said water channel whereby water flow may be controlled,
a piston actuator connected to said piston.

16. A hand-held, sanitary washer comprising:
a handle
said handle having a proximal handle end and a distal handle end, said proximal handle end having a water inlet,
a water channel containing water within said handle, fluidly connected to said water inlet,
a soap reservoir within said handle containing soap, said soap reservoir fluidly connected to said water channel, said soap reservoir having collapsible walls, said soap reservoir further having a filler cap whereby said soap may be introduced into said soap reservoir,
a sprayer head mounted to said distal handle end and fluidly connected to said water channel, said sprayer head having at least one water outlet fluidly connected to said water channel,
a water actuator connected to said water channel whereby water flow may be controlled,
a soap actuator fluidly connected to said soap reservoir and fluidly connected to said water channel whereby said soap may be introduced into said water channel.

17. A hand-held, sanitary washer of claim 1 wherein said water is filtered and obtained from a pressurized hot water source.

18. A hand-held, sanitary washer of claim 1 where in said hand-held, sanitary washer is fluidly connected to a water source by agarden hose adapter, to connect the bidet device to a garden hose, using a plurality of sizes of male and/or female threads.

19. A hand-held, sanitary washer of claim 1 where in said hand-held, sanitary washer is fluidly connected to a water source by a dual threaded universal faucet adapter consisting of an internal and external, dual threaded universal coupler, a body, a compression coupler, one or more rubber seals, an insert a sleeve, a nut, a segment of plastic tubing of a plurality of lengths; a bidet adapter to attach said segment of plastic tube to the water inlet of the bidet device, said bidet adapter consisting of an external housing, a tube pressure release, a tube release bushing, a tube grip locking washer, a tube locking casing, a rubber washer, and a water inlet grommet.

20. A hand-held, sanitary washer of claim 1 where in said hand-held, sanitary washer is fluidly connected to a water source by a rubber-headed universal faucet adapter consisting of a rubber headed coupler, a body, an intermediate coupler, an insert, a sleeve, a nut, and a new hose clamp, a segment of plastic tubing of a plurality of lengths; a bidet adapter to attach said segment of plastic tube to the water inlet of the bidet device, said bidet adapter consisting of an external housing, a tube pressure release, a tube release bushing, a tube grip locking washer, a tube locking casing, a rubber washer, and a water inlet grommet.
